(19) United States
(12) Patent Application Publication
(10) Pub. No.: US 2011/0220768 A1
(43) Pub. Date: Sep. 15, 2011

(54) PORTABLE MOUNTING ASSEMBLY

(76) Inventor: John W. Hayes, Cohasset, MN (US)

(21) Appl. No.: 13/045,262

(22) Filed: Mar. 10, 2011

Related U.S. Application Data
(60) Provisional application No. 61/312,914, filed on Mar. 11, 2010.

(51) Int. Cl. F16M 13/02; B23P 17/04; F16B 45/00; F16B 2/02

(52) U.S. Cl. 248/219.4; 29/428; 248/218.4

(57) ABSTRACT

A portable mount for providing an elevated equipment mount affixable to an elongated upright structure such as a tree trunk or an upright post. The portable mount is compact and low weight so as to be easily transportable into the field and mounted to an available upright structure. Alternatively, the portable mount can be mounted to the support structure of a portable structure such as a tent or a blind.

### FIELD OF THE INVENTION

The present invention relates to portable mounts for temporarily positioning and orienting a camera or other equipment at a desired location. More particularly, the present invention relates to portable mounts for mounting a camera or other equipment on an elongated upright structure, such as an upright post or tree trunk.

### BACKGROUND OF THE INVENTION

In an urban setting, an elevated mount or hook for positioning or orienting cameras or other equipment can be easily installed on a wall or other man-made elevated structure.

However, in more rural or undeveloped areas where man-made structures are scarce, an elevated mount or hook is more difficult to mount. While mounting structures can be affixed to elevated natural objects such as trees, doing so often damages the tree or natural objects. As such, a tradeoff often exists between convenience of an elevated mount or hook and the damage to the environment caused by mounting the mount or hook to natural object.

For example, when photographing natural settings or wildlife, photographers are often required to carry a tripod mount with them into the field to avoid having to affix a camera mount to a tree or other natural object. However, tripod mounts are often heavy or cumbersome especially when carried across difficult terrain. As such, photographers are often forgo the tripod and brace themselves or the camera against a solid structure or perform some other awkward action to properly stabilize the camera when in the field. Furthermore, the photographer must hold the camera in their hands maintain the position and orientation of the camera. As a result, the photographer cannot use their hands to perform other actions or simply move around to determine if the camera's orientation is ideal without changing the position or orientation of the camera.

Similarly, hunters are often required to constantly hold their bow or firearm in their hands when waiting for prey. When positioned in an elevated position such as a tree stand, holding the bow prevents the hunter from performing other activities with their hands or forces the hunter to perform the activity while holding the bow or firearm, which can create a substantial safety risk. However, there is often no safe place to position or store the bow or firearm particularly when the hunter is positioned in an elevated position.

As such, there is a need for lightweight and easily transportable means of positioning and fixing the orientation of a camera or other similar equipment in the field without the aid of tripod mount.

### SUMMARY OF THE INVENTION

The present invention is directed to a portable mount having a mount member and a hook member for affixing the mount member to an elongated upright structure such as an elongated upright structure such as a tree trunk or an upright post. The portable mount provides a low weight and portable system for positioning and orienting equipment that uses upright structures found in the field instead of requiring tripod or other types of portable support structures. Alternatively, the portable mount can be affixed to the support structure of portable structures such as tents or blinds. In this configuration, the portable mount reduces the amount equipment that must be transported into the field by allowing the support structure of a portable structure to serve as the support structure of both the portable structure and the equipment mounted on the portable mount.

The portable mount, according to an embodiment of the present invention, can generally comprise a hook member and a mount member. The mount member is adjustably mounted to the hook member for adjustably mounting a camera or other equipment to an elongated upright structure. The mount member can be adapted to accept a threaded shank for engaging the universal threaded bore of most conventional cameras. Alternatively, the mount member can be adapted to receiving a straight shank to provide substantially horizontal rest for receiving equipment or a hooked shank to provide a hooked rest for receiving equipment. The mount member can further comprise a ball and socket assembly for positioning and orienting a camera or other equipment affixed to the mount member.

The above summary of the various representative embodiments of the invention is not intended to describe each illustrated embodiment or every implementation of the invention. Rather, the embodiments are chosen and described so that others skilled in the art can appreciate and understand the principles and practices of the invention. The figures in the detailed description that follow more particularly exemplify these embodiments.

### BRIEF DESCRIPTION OF THE FIGURES

The invention can be completely understood in consideration of the following detailed description of various embodiments of the invention in connection with the accompanying drawings, in which:

FIG. 1 is a perspective view of the portable mount of the present invention;

FIG. 2 is a perspective view of the portable mount of the present invention;

FIG. 3 is a perspective view of the mount member of the portable mount of the present invention coupled to the hook member;

FIG. 4 is a perspective view of the mount member of the portable mount of the present invention coupled to the hook member;

FIG. 5 is a perspective view of a disassembled mount member of the portable mount of the present invention;

FIG. 6 is a perspective view of a further embodiment of the mount member of the portable mount of the present invention;

FIG. 7 is a perspective view of the mount member of FIG. 6;

FIG. 8 is a perspective view of a trail cam mount with an exemplary trial camera supported by the mount;

FIG. 9 is a top plan form view of the trail cam mount;

FIG. 10 is a top plan form view of the trail cam mount and a side perspective view of the mount member;

FIG. 11 is an exploded view of a first portion of the trail cam mount;

FIG. 12 is a perspective view of a disassembled trail cam mount; and

FIG. 13 is a perspective view of a first portion of the trail cam mount.

FIG. 14 is a perspective view of a portable mount having a clamp attachment assembly of the present invention.

FIG. 15 is a perspective view of a portable mount having a linear support surface of the present invention.

FIG. 16 is a perspective view of a portable mount having a clamp attachment assembly of the present invention.

FIG. 18 is a perspective view of a portable mount having multiple mount members of the present invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION OF THE FIGURES

The portable mount of the present invention is shown generally at 10 in the drawings. Portable mount 10 comprises a hook member 12 and a mount member 14.

The hook member 12 further comprises a strap 20 and a hook 22. The strap 20 comprises a first strap portion 24 and a second strap portion 26. The first strap portion 24 has a first end 28 that is fixedly coupled to a loop 40 (described in greater detail below). The fixed coupling can be made by sewing the first end 28 of the first strap portion 24 to the loop 40, but other means of coupling could be utilized such as a rivet, bonding, fusing, and the like.

A second end 30 of the first strap portion 24 is fixedly coupled to a buckle 32 by means similar to that described above for the first end 28. The buckle 32 has a biased clasp 34 that can be manually opened for engaging the second strap portion 26 as desired. It is to be understood that other means of temporarily connecting the first strap portion 24 to the second strap portion 26 can be utilized such as hook and pile material.

The second strap portion 26 has a first end 36 that is fixedly coupled to the loop 40 by means such as those noted above for the first end 28 of the first strap portion 24. The second end 38 of the second strap portion 26 can be passed through a slot 39 formed in the buckle 32. The second component of the hook member 12 is the hook 22. At a first end, the loop 40 is formed. Preferably, the loop 40 is formed in a rectangular shape with a first side for fixedly engaging the first strap portion 24 and a second opposed side for fixedly engaging the second strap portion 26.

A shank 42 depends from the loop 40. At a distal end of the shank 42, a hook 44 is formed. The hook 44 has an S-curved section 46 that is coupled to the shank 42. The S-curved section 46 leads into a straight section 48 that is disposed generally transverse to the depending shank 42.

According to an embodiment of the present invention, the hook member 12 can alternatively comprise a clamp 180 having at least two jaws 182 joined at one end by a hinge 184 instead of a strap 20. In this configuration, the shank 42 depends from one of the jaws 182. In operation, the jaws 182 can be closed around the support structure of a portable structure such as a tent or a blind. According to an embodiment of the present invention, the clamp 180 can further comprise a thumb screw 186 threaded through the jaws 182 opposite the hinge 184. The thumb screw 186 can be adjusted to set the extent to which the jaws 182 can open or close so as to accommodate different sizes of support structure.

As shown in the Figures, the portable mount 10 also comprises the mount member 14. The mount member 14 includes a block 60 that is preferably formed of a metallic material, although materials such as nylon and Delrin and the like could also be used. The block 60 has rectangular sides 62 and rectangular ends 64. A blind bore 66 is formed along the center axis of block 60 extending from a first end 64a. Blind bore 66 is not threaded.

A threaded bore 68 extends through the block 60 from side-to-side and is transverse with respect to the blind bore 66. The threaded bore 68 intersects the blind bore 66. A thumb screw 70 has a threaded shank 72 and a generally T-shaped handle 74. The thumb screw 70 can be threaded into either of the two ends of the threaded bore 68.

A second threaded bore 76 extends side-to-side in the block 60 and is disposed generally parallel to the longitudinal axis of threaded bore 68. A second thumb screw, thumb screw 78 can be threaded into the threaded bore 76. The thumb screw 78 has a threaded shank 80 and a handle 82.

A third thumb screw, thumb screw 84 is utilized in conjunction with the mount member 14. Thumb screw 84 has a threaded shank 86 upon which a wing nut 88 can be threadedly disposed.

The threaded shank 86 is capped with a handle 90. A transverse bore 92 is defined in the handle 90. Transverse bore 92 is of sufficient size that the threaded shank 80 of the thumb screw 78 can pass readily therethrough.

In operation, the second strap portion 26 is wrapped around the trunk of a suitable tree and passed through the slot 39 of the buckle 32. The strap 20 is then snugged up and the bias clasp 34 of the buckle 32 is engaged with the second strap portion 26 to hold the portable mount on the trunk of the tree.

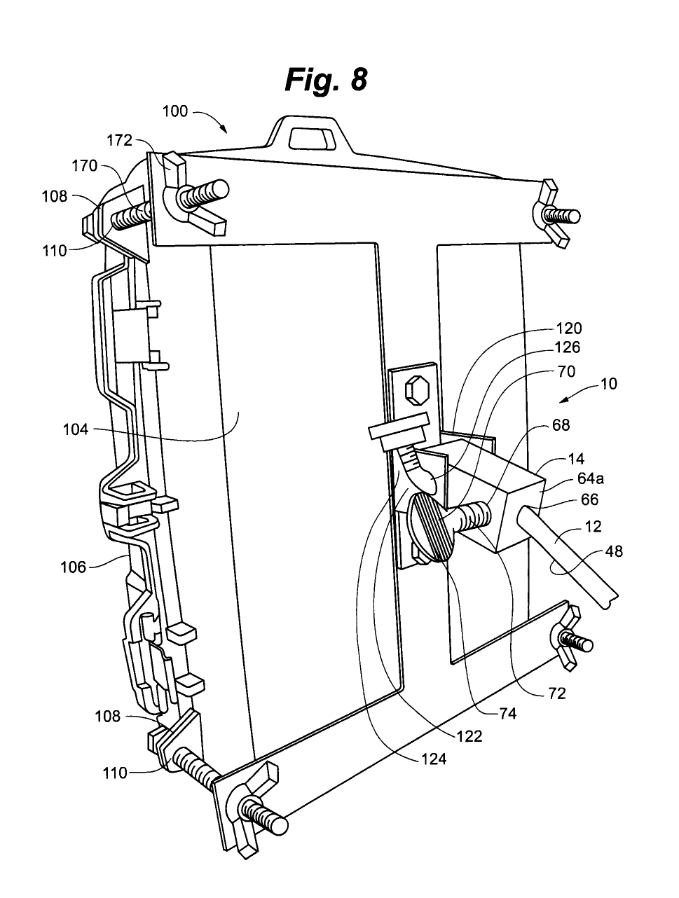

The straight section 48 of the hook 44 is passed into the blind bore 66. In this disposition, the mount member 14 can be rotated about the straight section 48 to provide a first degree of rotational movement, as indicated by arrow 94 in FIG. 8. When the mount member 14 is at its desired rotational disposition with respect to the straight section 48, the thumb screw 70 can be threaded into the threaded bore 68 to fixedly engage the straight section 48.

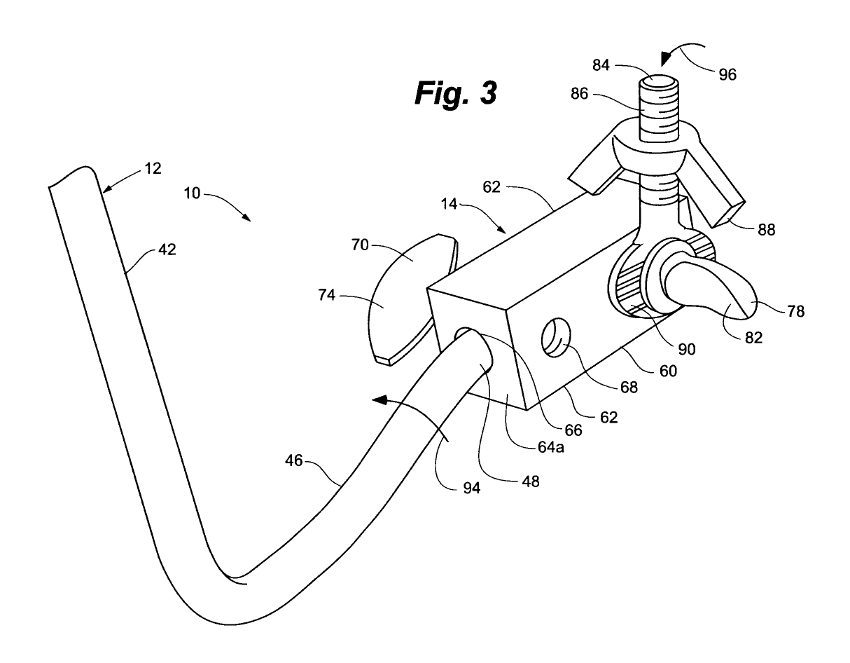

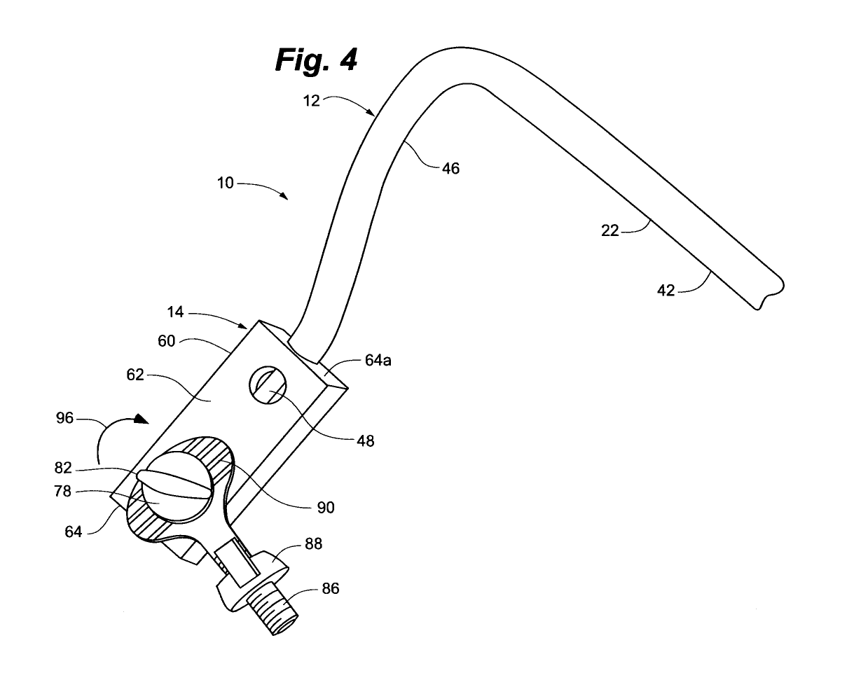

The thumb screw 78 is passed through the transverse bore 92 and threadedly engaged with the threaded bore 76. The wing nut 88 can be rotated relative to the block 60 as indicated by the arrow 96 in FIGS. 3 and 4, thus providing the second degree of freedom of motion.

A camera can then be threaded onto the threaded shank 86 of the thumb screw 84. The wing nut 88 can be positioned against to the underside of the camera in order to ensure that the camera stays in place. After the camera is in place, either the thumb screw 78 or the thumb screw 70 could be loosened to shift the angle of disposition of the camera as desired.

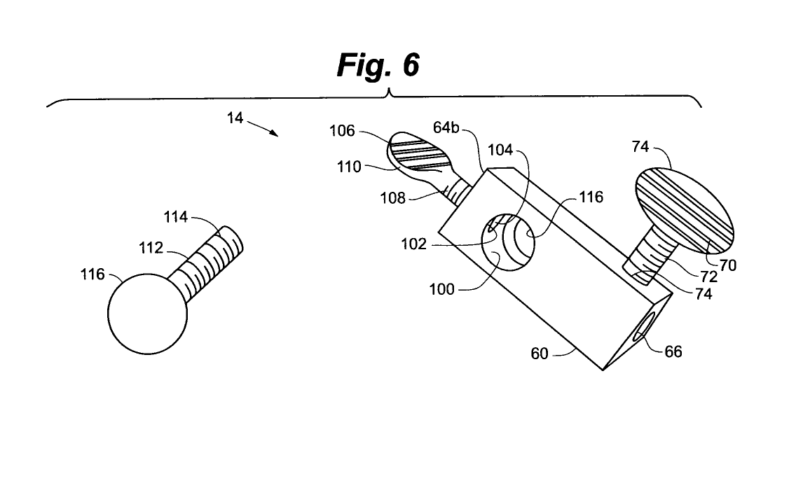

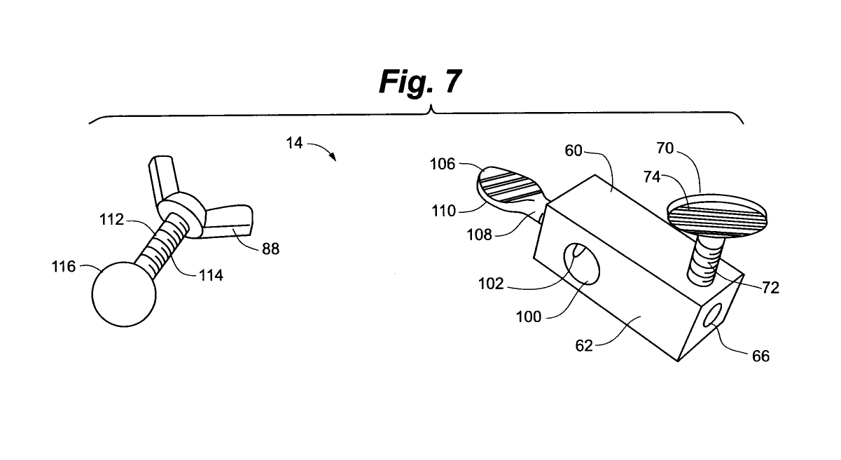

FIGS. 6 and 7 depict a further embodiment of the mount member 14. In addition to the blind bore 66 and thumb screw 70 for mounting the mount member 14 to the straight section 48, the mount member 14 of the present embodiment includes a transverse bore 100 having a socket 102 that extends partially through the block 60. A threaded bore 104 extends from the end 64b to intersect the socket 102. A thumb screw 106 having a threaded shank 108 and a handle 110 can be disposed in the threaded bore 104. A ball device 112 has a threaded shank 114 and a ball 116. According to an embodiment of the present invention, a partially threaded shank 188 having a non-threaded portion 190 can be used instead of the threaded shank 114. The non-threaded portion 190 can be linear to provide a linear support surface for a piece of equipment or non-linear to provide a non-linear support surface for a piece of equipment. According to an embodiment of the present invention, the partially threaded shank 188 can comprise threading on either side of the non-threaded portion 190 so to be engagable to two mount members 14. In this configuration, the partially threaded shank 188 can act as an extension or a positioning arm to orient any equipment attached to the second mount member 14.

In operation, the ball 116 is inserted into the socket 100 and the camera can be threadedly engaged with the shank 114. The ball 116 can rotate 360 degrees within the socket 102. Additionally, the ball device can wobble in any direction in the 360 degrees as constrained by the shank 114 coming into contact with the rim 116 of the socket 102, thereby providing a third degree of freedom of motion.

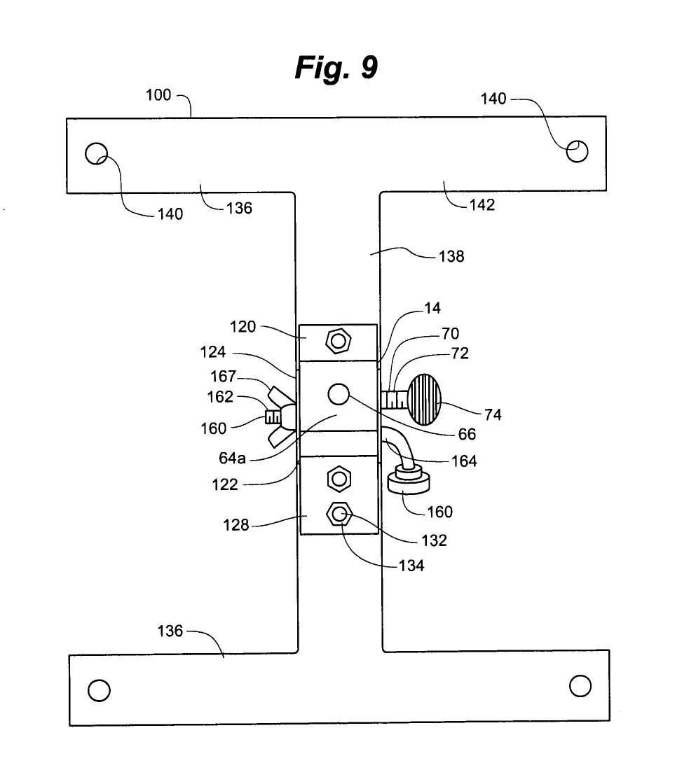

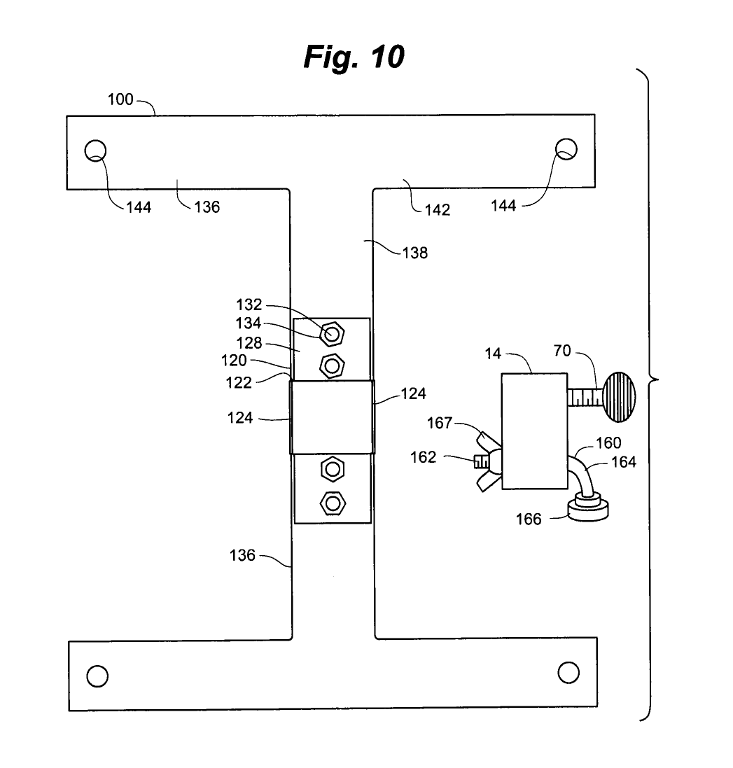

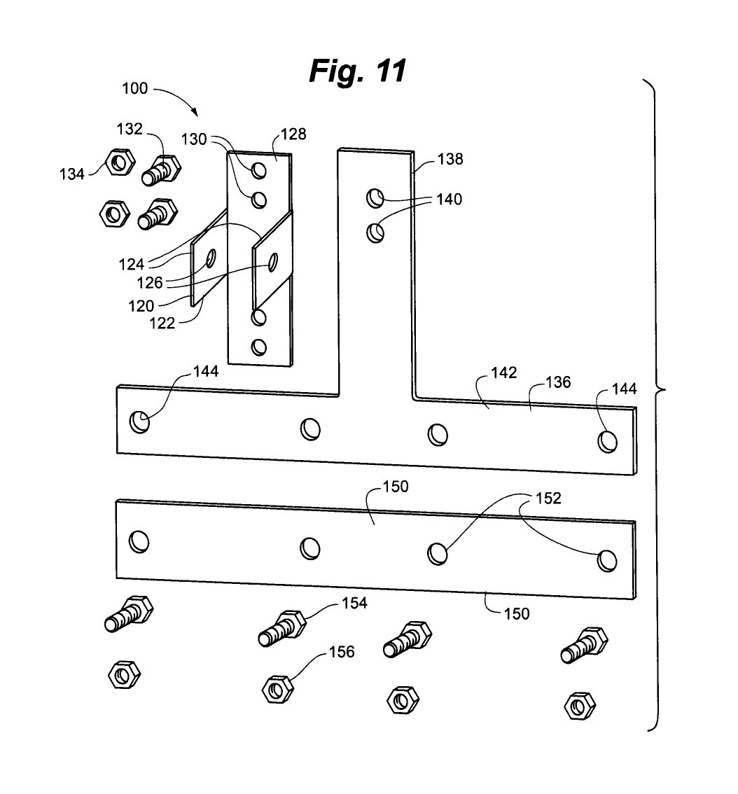

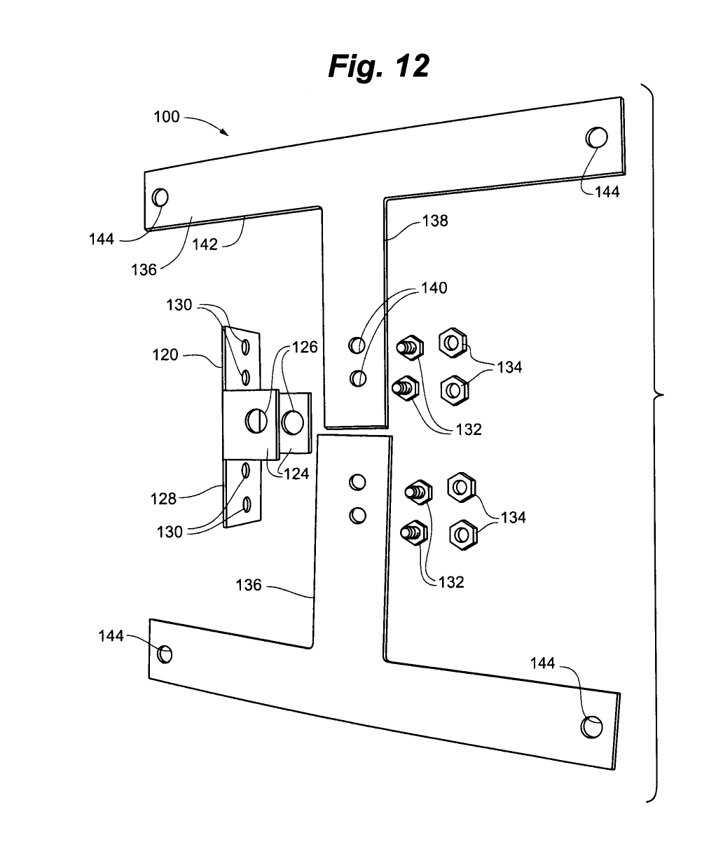

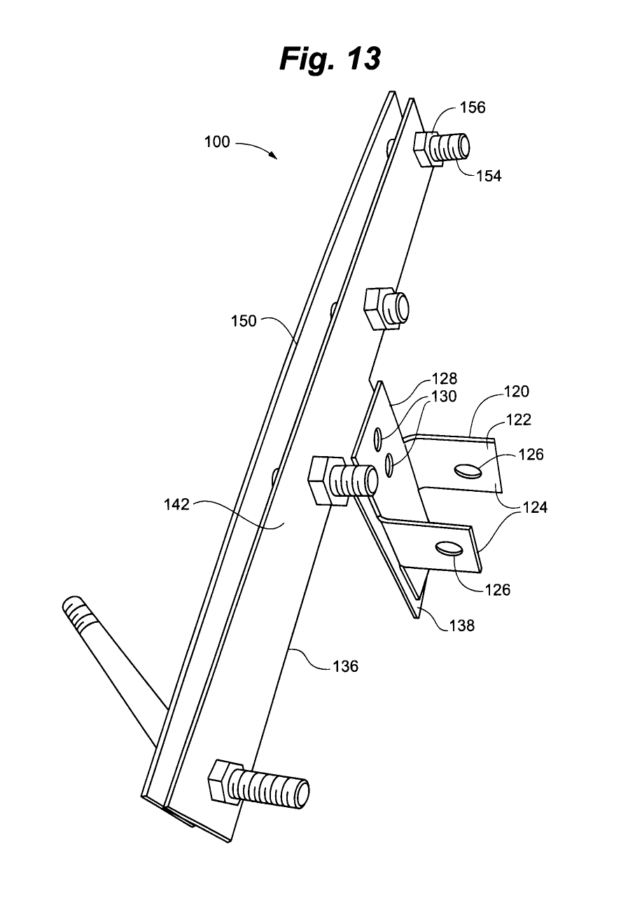

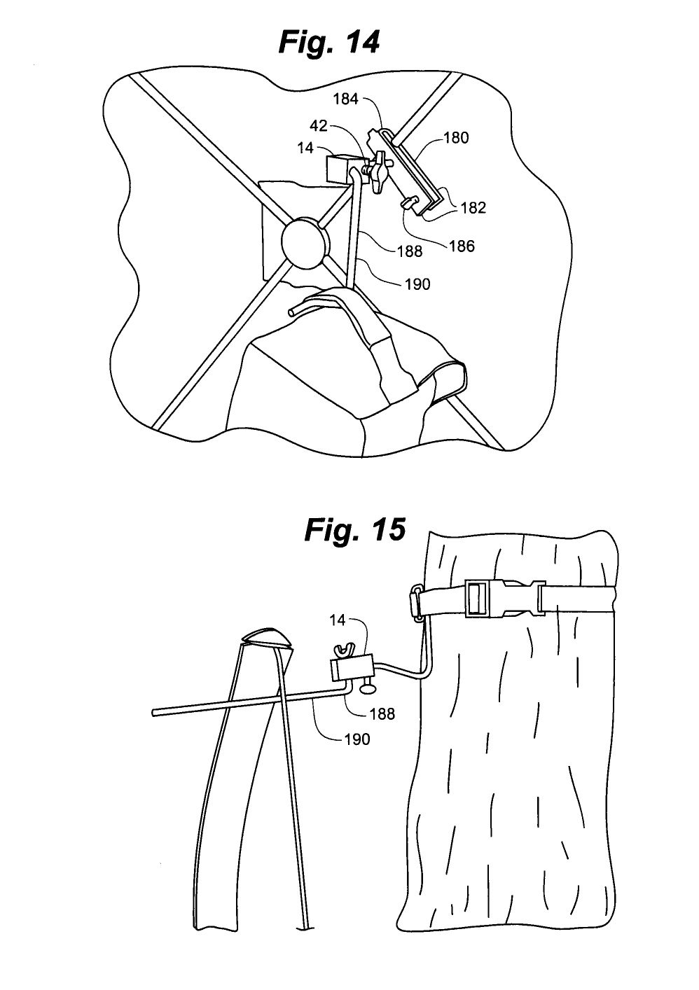

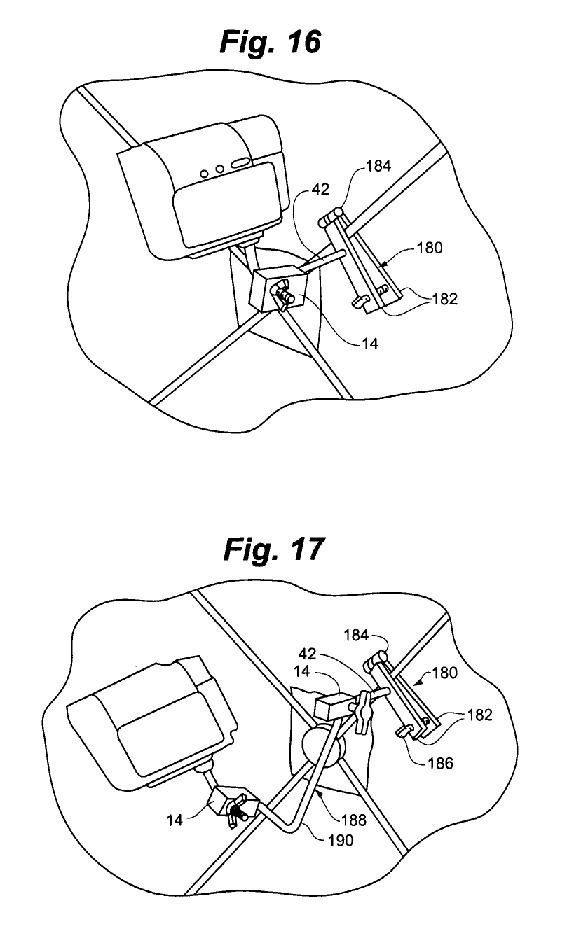

A further embodiment of the present invention is a trail cam mount shown generally at 100 in FIGS. 8-13. A trail camera 102 is depicted in FIG. 8. Trail cameras are utilized by sportsmen and sportswomen to record animal passage along a trail at times when the person is not present. Typically, a trail camera is motion sensitive and will either take an infrared picture or a more traditional picture with a flash that is simultaneously activated.

The exemplary trail camera 120 has a rear face 104 and opposed front face 106 at a pair of brackets 108 disposed on a side of the trail camera 102. Each of the brackets 108 has a bore 110 defined therethrough.

Trail cam mount 100 includes a mount bracket 120. The mount bracket 120 has a U-shaped bracket member 122 with opposed sides 124 for forming a portion of the U-shape. Each of the opposed sides 124 has a bore 126 defined therein. The two bores 126 are in registry with one another. A base plate 128 forms the bottom of the U-shape and extends outward from both sides of the opposed sides 124. The base plate 128 has a plurality of bores 130 defined therein. The bores 130 are adapted to receive respective bullets 132, the bullets 132 each having a respective nut 134.

A second component of the trail cam mount 100 is a T bracket 136. As depicted in the figures, there are preferably two T brackets 136 there forms substantially identically. A first T bracket 136 extends outward from the base plate 128 in a first direction and a second T bracket 136 extends outward from the base plate 128 in a second opposed direction.

The T bracket 136 has a first leg 138 with a plurality of bores 140 defined therein. The first leg 138 is operably coupled to a cross-leg 142. The cross-leg 142 has a plurality of bores 144 defined therein.

The trail cam mount 100 further includes a backing bar 150. The backing bar 150 includes a plurality of bores 152 defined therethrough. A plurality of bolts 154 and a respective nut 156 for each of the bolts 154 is further included.

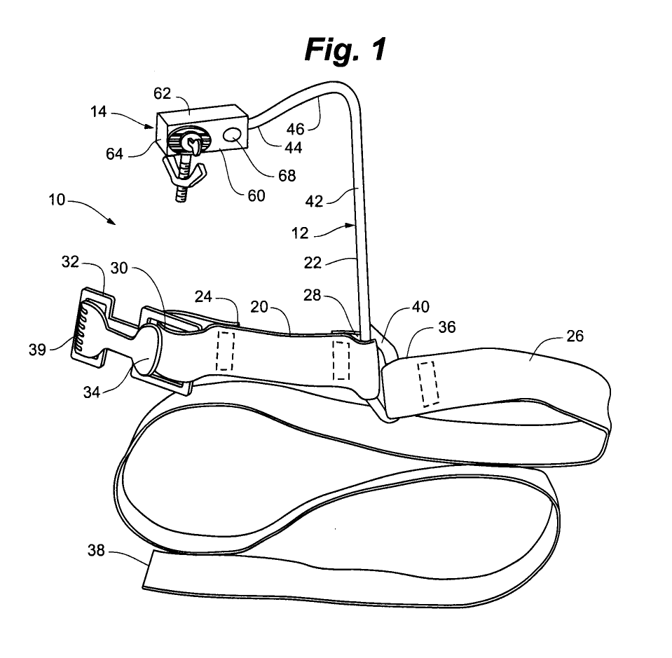

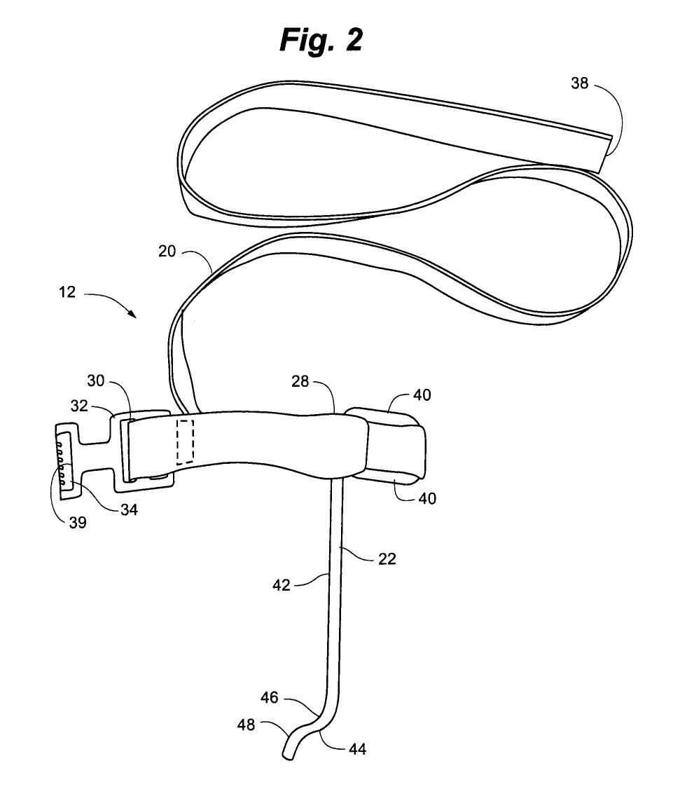

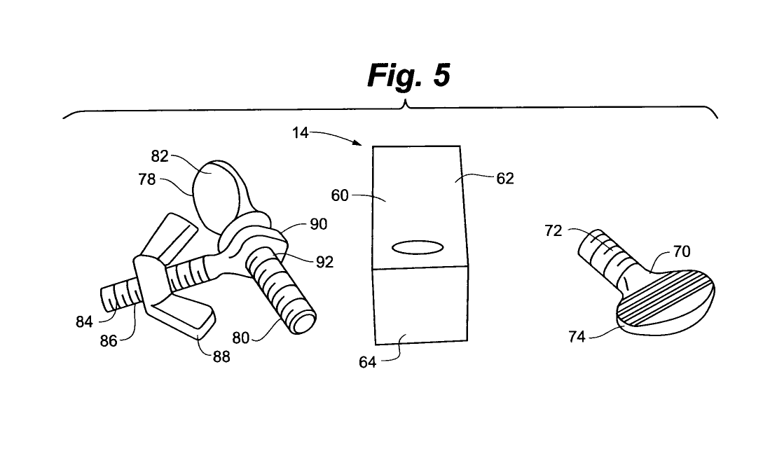

Unlike the embodiment of FIGS. 1-7, the mount member 14 utilized with the trail cam mount 100 includes a right angle bolt 160. The right angle bolt 160 is threaded at a first end with threads 162 and a second end with threads 164. A stop nut 166 is threaded onto threads 162 and a wing nut 167 is threaded onto threads 164. The right angle bolt 160 resides in a transverse bore 168 defined through the mount member 14. The transverse bore 168 is disposed in generally the same disposition as the threaded bore 74 noted above. Unlike the threaded bore 74, the transverse bore 168 is simply a bore presenting a smooth inner margin.

In operation, the two T brackets 136 are bolted to the U-shaped bracket member 122 by means of the respective bolts 132 and nuts 134, the bolts 132 passing through the bores 130 and the bores 140. Such action gives you the configuration of the mount bracket 120 as depicted in FIG. 8.

Referring to FIG. 8, the trail camera 102 is captured between the cross-leg 142 of the respective T brackets 136 and the backing bar 150. Trail camera 102 is secured in this disposition by means of bolts 170 passed through a bore 152 of the backing bar 150. The bolt 170 is then passed through the bore 110 defined in the bracket 108 of the trail camera 102 and thence through a bore 140 defined in a T bracket 136. The bolt 170 is secured in place by means of a wing nut 172. The trail cam mount 100 is shiftably affixed to the mount member 14 by passing a leg of the right angle bolt 160 through a first bore 126, the transverse bore 168, and the second bore 126. The trail cam mount 100 is then affixed at the desired angle relative to the mount member 14 by means of the wing nut 167. It should be understood that when the trail cam mount 100 is not utilized with the mount member 14, the right angle bolt 160 can perform the function of being threadably engaged with the base of a conventional camera as described above, the camera being secured in place by means of the stop nut 166 and the angular disposition of the camera relative to the mount member 14 being fixed by the wing nut 167.

Although specific examples have been illustrated and described herein, it will be appreciated by those of ordinary skill in the art that any arrangement calculated to achieve the same purpose could be substituted for the specific examples shown. This application is intended to cover adaptations or variations of the present subject matter. Therefore, it is intended that the invention be defined by the attached claims and their legal equivalents, as well as the following illustrative embodiments.

What is claimed is:

1. A portable mount affixable to an elongated upright structure to provide an elevated equipment mounting point comprising:
a hook member having a shank and an adjustable attachment apparatus engagable to the elongated upright structure such that the shank extends generally outward from the elongated upright structure;
a mount member having a blind bore for receiving a portion of the shank to position the mount member on the hook member and a transverse bore; and
a support assembly having a threaded shank receivable within the transverse bore and an equipment mount.

2. The portable mount of claim 1, wherein the adjustable attachment apparatus further comprises:
at least one strap positionable around the elongated the support structure; and
at least one buckle engagable to the hook member and adapted to receive the at least one strap to secure the hook member to the elongated support structure.

3. The portable mount of claim 1, wherein the adjustable attachment apparatus further comprises:
a clamp engagable to the hook member and having at least two jaws positionable on opposing sides of the support structure for releasably gripping the support structure.

4. The portable mount of claim 1, wherein the support assembly further comprises:
an adjustable ball and socket assembly positioned between the equipment mount and the mount member such that the equipment mount can be rotated and positioned in a plurality of positions relative to mount member.

5. The portable mount of claim 1, wherein the equipment mount comprises a threaded shank for interfacing with a universal tripod mount of a camera.

6. The portable mount of claim 1, wherein the equipment mount comprises a linear elongated shank providing a linear support surface for supporting a piece of equipment.

7. The portable mount of claim 1, wherein the equipment mount comprises a non-linear elongated shank providing a non-linear support surface for supporting a piece of equipment.

8. A system for providing an elevated equipment mounting point comprising:
an elongated upright structure;
a hook member having a shank and an adjustable attachment apparatus engagable to the elongated upright structure such that the shank extends generally outward from the elongated upright structure;
a mount member having a blind bore for receiving a portion of the shank to position the mount member on the hook member and a transverse bore; and
a support assembly having a threaded shank receivable within the transverse bore and a equipment mount.

9. The portable mount of claim 8, wherein the adjustable attachment apparatus further comprises:
at least one strap positionable around the elongated support structure; and
at least one buckle engagable to the hook member and adapted to receive the at least one strap to secure the hook member to the elongated support structure.

10. The portable mount of claim 8, wherein the adjustable attachment apparatus further comprises:
a clamp engagable to the hook member and having at least two jaws positionable on opposing sides of the support structure for releasably gripping the support structure.

11. The portable mount of claim 8, wherein the support assembly further comprises:
an adjustable ball and socket assembly positioned between the equipment mount and the mount member such that the equipment mount can be rotated and positioned in a plurality of positions relative to mount member.

12. The portable mount of claim 8, wherein the equipment mount comprises a threaded shank for interfacing with a universal tripod mount of a camera.

13. The portable mount of claim 8, wherein the equipment mount comprises a linear elongated shank providing a linear support surface for supporting a piece of equipment.

14. The portable mount of claim 8, wherein the equipment mount comprises a non-linear elongated shank providing a non-linear support surface for supporting a piece of equipment.

15. A method for providing an elevated equipment mounting point comprising:
providing a portable mount member comprising:
a hook member having a shank and an adjustable attachment apparatus,
a mount member, and
a support assembly having an equipment mount;
locating an elongated upright structure;
adjustably affixing the hook member to the elongated upright structure such that the shank of the hook member extends outwardly from elongated upright structure;
positioning the mount member on the tip of the shank such that the mount member is positioned above the ground; and
adjustably attaching the support assembly to the mount member.

16. The method of claim 15, wherein the adjustable attachment apparatus further comprises:
at least one strap positionable around the elongated the support structure; and
at least one buckle engagable to the hook member and adapted to receive the at least one strap to secure the hook member to the elongated support structure.

17. The method of claim 15, wherein the adjustable attachment apparatus further comprises:
a clamp engagable to the hook member and having at least two jaws positionable on opposing sides of the support structure for releasably gripping the support structure.

18. The method of claim 15, wherein the support assembly further comprises:
an adjustable ball and socket assembly positioned between the equipment mount and the mount member such that the equipment mount can be rotated and positioned in a plurality of positions relative to mount member.

19. The method of claim 15, wherein the equipment mount comprises a threaded shank for interfacing with a universal tripod mount of a camera.
